(19) United States
(12) Patent Application Publication
(10) Pub. No.: US 2026/0186115 A1
(43) Pub. Date: Jul. 2, 2026

(54) SYSTEM FOR CALIBRATION OF AN ULTRASOUND PROBE BASED ON DETERMINED SENSITIVITES OF TRANSDUCER ELEMENTS OF THE ULTRASOUND PROBE

(71) Applicant: GE Precision Healthcare LLC, Waukesha, WI (US)

(72) Inventors: Harald WEICHENBERGER, Oberhofen am Irrsee (AT); Teresa RIEDER, St. Pantaleon (AT)

(21) Appl. No.: 19/005,219

(22) Filed: Dec. 30, 2024

(51) Int. Cl. G01S 7/52; G01S 7/62; G01S 15/89

(52) U.S. Cl. CPC G01S 7/52004; G01S 7/62; G01S 15/89

(57) ABSTRACT

An ultrasound system may include a lens, an acoustic matching layer, an acoustic dematching layer, and a plurality of transducer elements. The ultrasound system may include a memory configured to store instructions; and one or more processors configured to execute the instructions to determine a sensitivity of a transducer element of the plurality of transducer elements. The one or more processors may determine a correction factor for the transducer element based on the determined sensitivity. The one or more processors may control an arbitrary waveform transmitter to generate an element specific transmit signal based on the correction factor for the transducer element. The one or more processors may control the arbitrary waveform transmitter to transmit the element specific transmit signal to the transducer element to cause the transducer element to generate an ultrasound signal.

### TECHNICAL FIELD

The present disclosure relates, generally, to a system for calibration of an ultrasound probe based on determined sensitivities of transducer elements of the ultrasound probe. More specifically, the present disclosure relates to a system that determines respective sensitivities of the transducer elements of the ultrasound probe, and controls an arbitrary waveform transmitter of the ultrasound probe to generate element specific transmit signals for the transducer elements.

### BACKGROUND

An ultrasound system may include, among other things, a console and an ultrasound probe. The console may house various components of the ultrasound system, such as a transmitter, a receiver, a processor, a display, etc. The ultrasound probe may connect to the console, and may include various transducer elements provided in a specific configuration. The transmitter may generate electrical signals, and transmit the electrical signals to the transducer elements of the ultrasound probe. The transducer elements may receive the electrical signals from the transmitter, transform the electrical signals to ultrasound signals, and transmit the ultrasound signals towards a region of interest of a subject. The ultrasound signals may be reflected by, or back-scattered from, the region of interest of the subject to generate echo signals that are reflected towards the ultrasound probe. The transducer elements of the ultrasound probe may receive the echo signals, transform the echo signals to electrical signals, and transmit the electrical signals to the receiver. The ultrasound system may generate ultrasound images based on the electrical signals received by the receiver.

A sensitivity of a transducer element may refer to a relationship between an input to the transducer element and an output of the transducer element. For example, a sensitivity of a transducer element may refer to a ratio between an amplitude of an electrical signal provided to the transducer element and an amplitude of an ultrasound signal generated by the transducer element. A transducer element of the ultrasound probe might have an expected sensitivity and might also have an actual sensitivity that might, or might not, correspond to the expected sensitivity. For example, an actual sensitivity of a transducer element might deviate from an expected sensitivity based on manufacturing tolerances, based on degradation of the transducer element with usage, or the like. In this case, the transducer element might generate an ultrasound signal that is weaker, or different, than as expected. Further, the respective sensitivities of the transducer elements may vary. The foregoing deviations may result in the ultrasound system generating ultrasound images that are low quality, or the like. Accordingly, a technical need exists for calibration of ultrasound probes to account for variations in sensitivities of transducer elements.

### SUMMARY

This summary introduces concepts that are described in more detail in the detailed description. It should not be used to identify essential features of the claimed subject matter, nor to limit the scope of the claimed subject matter.

In an aspect, an ultrasound system may include an ultrasound probe comprising a lens, an acoustic matching layer, an acoustic dematching layer, and a plurality of transducer elements; a memory configured to store instructions; and one or more processors configured to execute the instructions to: determine a sensitivity of a transducer element of the plurality of transducer elements; determine a correction factor for the transducer element based on the determined sensitivity; control an arbitrary waveform transmitter to generate an element specific transmit signal based on the correction factor for the transducer element; and control the arbitrary waveform transmitter to transmit the element specific transmit signal to the transducer element to cause the transducer element to generate an ultrasound signal.

In another aspect, a method may include determining a sensitivity of a transducer element of a plurality of transducer elements of an ultrasound probe comprising a lens, an acoustic matching layer, an acoustic dematching layer, and the plurality of transducer elements; determining a correction factor for the transducer element based on the determined sensitivity; controlling an arbitrary waveform transmitter to generate an element specific transmit signal based on the correction factor for the transducer element; and controlling the arbitrary waveform transmitter to transmit the element specific transmit signal to the transducer element to cause the transducer element to generate an ultrasound signal.

In yet another aspect, a non-transitory computer-readable medium may store instructions that, when executed by one or more processors of an ultrasound system, cause the one or more processors to: determine a sensitivity of a transducer element of the plurality of transducer elements of an ultrasound probe comprising a lens, an acoustic matching layer, an acoustic dematching layer, and a plurality of transducer elements; determine a correction factor for the transducer element based on the determined sensitivity; control an arbitrary waveform transmitter to generate an element specific transmit signal based on the correction factor for the transducer element; and control the transmitter to transmit the element specific transmit signal to the transducer element to cause the transducer element to generate an ultrasound signal.

### BRIEF DESCRIPTION OF DRAWINGS

FIG. 1 is a diagram of an example ultrasound system.

FIG. 2 is a diagram of an example ultrasound probe.

FIG. 3 is a flowchart of an example process for controlling an arbitrary waveform transmitter to transmit an element specific transmit signal to a transducer element.

FIGS. 4A and 4B are diagrams of an example process for controlling an arbitrary waveform transmitter to transmit an element specific transmit signal to a transducer element.

FIG. 5 is a flowchart of an example process for determining a correction factor for a transducer element while an ultrasound probe is in a calibration mode.

FIGS. 6A and 6B are diagrams of an example process for determining a correction factor for a transducer element while an ultrasound probe is in a calibration mode.

FIG. 7 is a flowchart of an example process for determining a correction factor for an ultrasound system using a calibration circuit.

FIG. 8 is a diagram of an example process for determining a correction factor for an ultrasound system using a calibration circuit.

### DETAILED DESCRIPTION

As described above, a transducer element of an ultrasound probe might have an expected sensitivity that corresponds to a relationship between an input to the transducer element and an output of the transducer element. Further, the transducer element might also have an actual sensitivity that might, or might not, correspond to the expected sensitivity. For example, an actual sensitivity of a transducer element might deviate from an expected sensitivity based on manufacturing tolerances, based on degradation of the transducer element from usage, or the like. In this case, the transducer element might generate an ultrasound signal that is weaker than as expected. Further, the respective sensitivities of the transducer elements may vary. Accordingly, the ultrasound probe may generate ultrasound signals that include amplitudes that deviate from expected amplitudes. The foregoing deviations may result in the ultrasound system generating ultrasound images that are low quality, or the like.

Some embodiments herein provide for calibration of an ultrasound probe based on determined sensitivities of transducer elements of the ultrasound probe. For instance, an ultrasound system may determine a sensitivity of a transducer element of a plurality of transducer elements of an ultrasound probe; determine a correction factor for the transducer element based on the determined sensitivity; control an arbitrary waveform transmitter to generate an element specific transmit signal based on the correction factor for the transducer element; and control the transmitter to transmit the element specific transmit signal to the transducer element to cause the transducer element to generate an ultrasound signal.

In this way, some embodiments herein provide a technical improvement in the technical field of ultrasound imaging by determining element specific sensitivities, determining element specific correction factors, and generating element specific transmits signals. In response to the element specific transmit signals, the transducer elements may generate respective ultrasound signals that have characteristics that more closely align with expected characteristics. In this way, the ultrasound system may generate ultrasound images that are of greater quality than as compared to situations where the element specific sensitivities are not accounted for during transmission.

Further, in this way, some embodiments herein provide a technical improvement to ultrasound systems by permitting the ultrasound system to determine element specific sensitivities, determine element specific correction factors, and generate element specific transmits signals. With this improved functionality, the ultrasound system may generate respective ultrasound signals that have characteristics that more closely align with expected characteristics, which may lead to the generation of ultrasound images that are of greater quality than as compared to situations where the element specific sensitivities are not accounted for during transmission.

Further, some embodiments herein provide a calibration technique that does not require any specific external devices. For instance, the calibration technique does not require the imaging of a phantom. Accordingly, the embodiments herein provide a technical improvement to calibration of ultrasound probes and ultrasound systems.

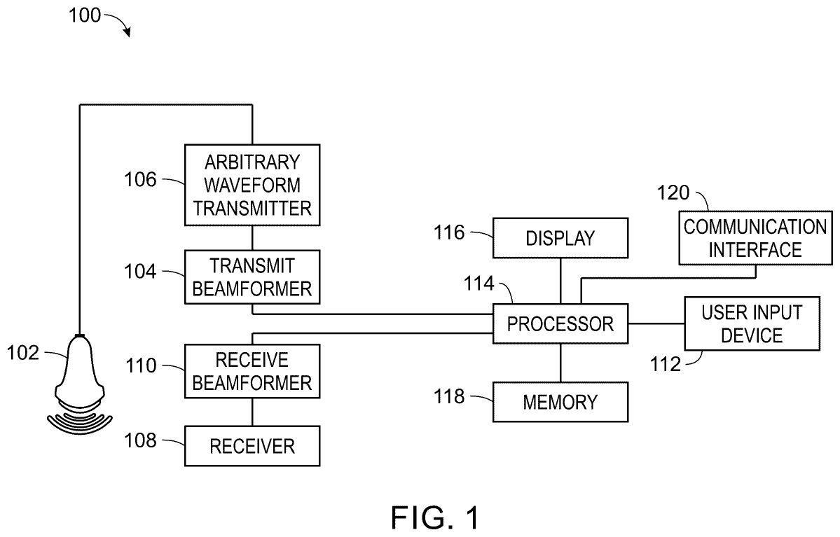

FIG. 1 is a diagram of an example ultrasound system 100. As shown in FIG. 1, the ultrasound system 100 may include an ultrasound probe 102, a transmit beamformer 104, an arbitrary waveform transmitter 106, a receiver 108, a receive beamformer 110, a user input device 112, a processor 114, a display 116, a memory 118, and a communication interface 120. The foregoing components may be connected via wired or wireless connections.

The ultrasound probe 102 may be configured to acquire ultrasound data. For example, the ultrasound probe 102 may be a linear probe, a phase array probe, a curved linear probe coupled with a position tracking system, a mechanically steered linear array transducer, a phased array transducer, a curved linear array transducer, an electronically steered 2D transducer array, an electronic 3D (e3D) probe, an electronic 4d (e4D) probe, a low profile wearable patch version of any of the foregoing probes, or the like. According to an embodiment, the ultrasound probe 102 may be configured to generate ultrasound signals, emit the ultrasound signals towards the region of interest of a subject, receive echo ultrasound signals that are reflected by or back-scattered from the region of interest of the subject, generate ultrasound data based on the echo ultrasound signals, and output the ultrasound data.

The transmit beamformer 104 may be configured to apply delay times to element specific transmit signals provided to transducer elements of the ultrasound probe 102 to focus corresponding ultrasound signals at the region of interest. The arbitrary waveform transmitter 106 may be configured to transmit element specific transmit signals to the transducer elements of the ultrasound probe 102 to drive the transducer elements to emit ultrasound signals towards the region of interest. The arbitrary waveform transmitter 106 may be a transmitter that is configured to shape electrical signals in the amplitude and time domain. The electrical signals may be rectangular, sinusoidal, triangular, or the like. The electrical signals may include limited time lengths or unlimited time lengths. The electrical signals may be any other electrical signal with single or multiple frequency components.

The transducer elements may be configured to receive the element specific transmit signals from the arbitrary waveform transmitter 106, transform the element specific transmit signals to ultrasound signals, and transmit the ultrasound signals towards the region of interest. The transducer elements may be configured to receive echo signals that are reflected by, or back-scattered from, the region of interest, transform the echo signals to electrical signals, and transmit the electrical signals to the receiver 108. The receiver 108 may be configured to receive the electrical signals from the transducer elements, and provide the electrical signals to the receive beamformer 110. The receive beamformer 110 may apply delay times to the electrical signals received from the transducer elements. The arbitrary waveform transmitter 106 and/or the receiver 108 may include one or more components, such as a pulser, a transmit/receive (T/R) switch, an analog front end (AFE) chip, or the like.

The user input device 112 may be configured to receive a user input, and provide the user input to the processor 114. For example, the user input device 112 may be a user interface, a touch screen display, a keyboard, a keypad, a mouse, a button, a switch, a microphone, or the like. Additionally, or alternatively, the user input device 112 may be configured to sense information. For example, the user input device 112 may sense information from an electro-magnetic positioning system, an inertial measurement system, an accelerometer, a gyroscope, an actuator, or the like.

The processor 114 may be configured to perform the operations as described herein. For example, the processor 114 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 114 may be implemented in hardware, firmware, or a combination of hardware and software. The processor 114 may include one or more processors 114 configured to perform the operations described herein. For example, a single processor 114 may be configured to perform all of the operations described herein. Alternatively, multiple processors 114, collectively, may be configured to perform all of the operations described herein, and each of the multiple processors 114 may be configured to perform a subset of the operations described herein. For example, a first processor 114 may perform a first subset of the operations described herein, a second processor 114 may be configured to perform a second subset of the operations described herein, etc.

The processor 114 may be configured to control the ultrasound probe 102 to acquire ultrasound data. The processor 114 may be configured to control which of the transducer elements are active, and control the shape of a beam emitted from the ultrasound probe 102. The processor 114 may generate ultrasound images for display. For example, the processor 114 may generate B-mode images, color Doppler images, M-mode images, color M-mode images, or the like. The ultrasound images may be 3D images, 2D images, single plane images, bi-plane images, three-plane images, multi-plane images, or the like. The ultrasound images may correspond to various anatomical planes (e.g., sagittal, coronal, and transverse) of the region of interest.

The display 116 may be configured to display information. For example, the display 116 may be a monitor, an LED display, a cathode ray tube, a projector display, a touchscreen, tablet computer, mobile phone, or the like. The display 116 may display ultrasound images based on the ultrasound data in real-time. For example, the display 116 may display the ultrasound images within one second, two seconds, five seconds, etc., of the ultrasound data being acquired by the ultrasound probe 102.

The memory 118 may be configured to store information and/or instructions for use by the processor 114. The memory 118 may be a non-transitory computer-readable medium that stores instructions for the processor 114. For example, the memory 118 may be a random access memory (RAM), a read only memory (ROM), and/or another type of dynamic or static storage device (e.g., a flash memory, a magnetic memory, and/or an optical memory) that stores information and/or instructions for use by the processor 114. The memory 118 may be configured to store instructions that, when executed by the processor 114, cause the processor 114 to perform the operations described herein.

The communication interface 120 may be configured to enable the processor 114 to communicate with other systems, such as via a wired connection, a wireless connection, or a combination of wired and wireless connections. For example, the communication interface 120 may include an Ethernet interface, an optical interface, a coaxial interface, an infrared interface, a radio frequency (RF) interface, a universal serial bus (USB) interface, a Wi-Fi interface, a cellular network interface, or the like.

The number and arrangement of the components of the ultrasound system 100 shown in FIG. 1 are provided as an example. In practice, the ultrasound system 100 may include additional components, fewer components, different components, or differently arranged components than those shown in FIG. 1. Additionally, or alternatively, a set of components (e.g., one or more components) of the ultrasound system 100 may perform one or more functions described as being performed by another set of components of the ultrasound system 100.

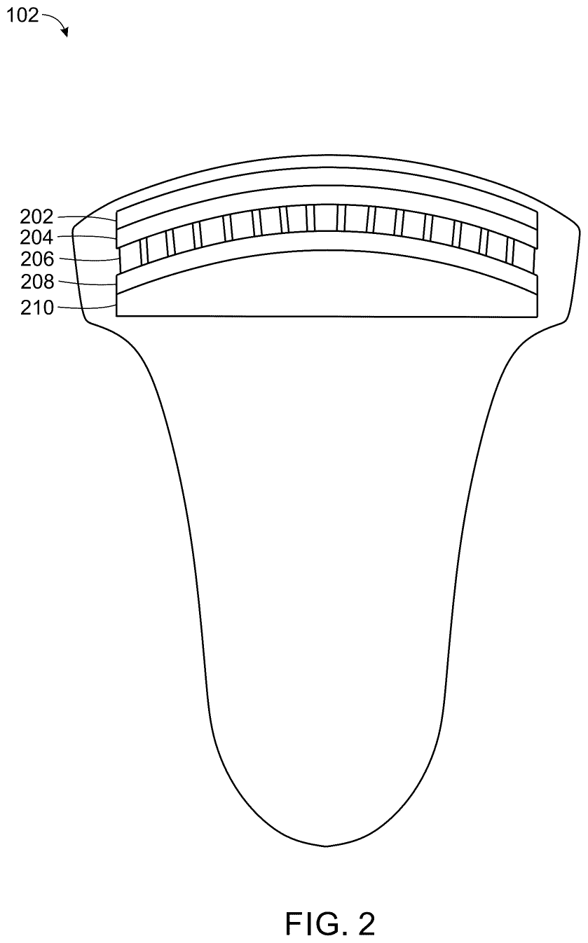

FIG. 2 is a diagram of an example ultrasound probe 102. As shown in FIG. 2, the ultrasound probe 102 may include a lens 202, an acoustic matching layer 204, transducer elements 206, an acoustic dematching layer 208, and a backing layer 210.

According to an embodiment, the lens 202 may be configured to direct an ultrasound signal towards the region of interest of the subject. For example, the lens 202 may be silicone, epoxy, rubber, or the like. According to an embodiment, the acoustic matching layer 204 may be configured to facilitate matching of an impedance differential that may exist between the relatively high impedance transducer elements 206 and the relatively low impedance subject. For example, the acoustic matching layer 204 may be graphite, plastic, resin, or the like. According to an embodiment, the transducer elements 206, respectively, may be configured to receive an element specific transmit signal, transform the element specific transmit signal to an ultrasound signal, and transmit the ultrasound signal towards a region of interest. Additionally, or alternatively, the transducer elements 206 may be configured to receive an echo signal reflected by or backscattered from the region of interest, transform the echo signal to an electrical signal, and transmit the electrical signal. For example, the transducer elements 206 may be piezoelectric materials, such as Pb(Mg_{1/3}Nb_{2/3})O₃—PbTiO₃ (“PMN-PT”), Pb(In_{1/2}Nb_{1/2})O₃—Pb(Mg_{1/3}Nb_{2/3})O₃—PbTiO₃ (“PIN-PMN-PT”), Pb(ZrTi) (“PZT”), or the like. According to an embodiment, the acoustic dematching layer 208 may be configured to decrease insertion losses and enhance a frequency bandwidth of the transducer elements 206. For example, the acoustic dematching layer 208 may be tungsten carbide, silicon carbide, or the like. According to an embodiment, the backing layer 210 may be configured to attenuate ultrasound signals directed from the transducer elements 206 in a direction opposite to the subject, and attenuate ultrasound signals deflected by a housing of the ultrasound probe 102. For example, the backing layer 208 may be an epoxy, a metal, or the like.

The number and arrangement of the components of the ultrasound probe 102 shown in FIG. 2 are provided as an example. In practice, the ultrasound probe 102 may include additional components, fewer components, different components, or differently arranged components than those shown in FIG. 2. Additionally, or alternatively, a set of components (e.g., one or more components) of the ultrasound probe 102 may perform one or more functions described as being performed by another set of components of the ultrasound probe 102.

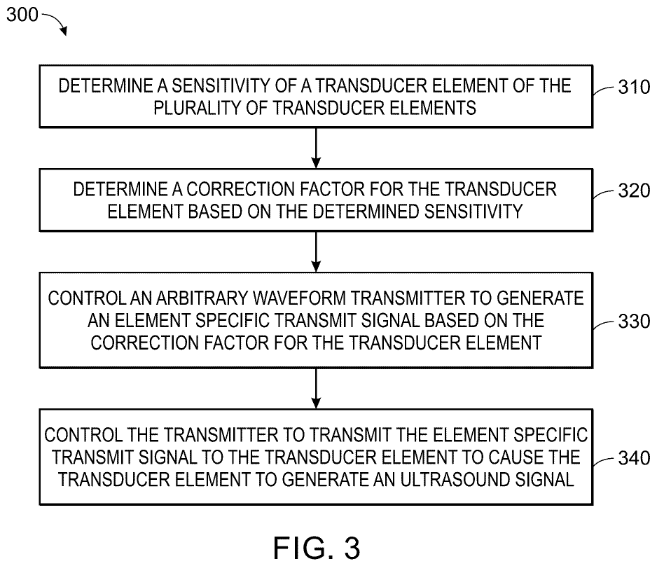

FIG. 3 is a flowchart of an example process 300 for controlling an arbitrary waveform transmitter to transmit an element specific transmit signal to a transducer element. According to an embodiment, the process 300 may be performed by the processor 114. Additionally, or alternatively, one or more operations of the process 300 may be performed by another component of the ultrasound system 100, such as the ultrasound probe 102, the transmit beamformer 104, the arbitrary waveform transmitter 106, the receiver 108, the receive beamformer 110, the user input device 112, the display 116, the memory 118, and/or the communication interface 120.

As shown in FIG. 3, the process 300 may include determining a sensitivity of a transducer element of the plurality of transducer elements (operation 310). The sensitivity may refer to a relationship between an input to a transducer element 206 and an output of the transducer element 206. For example, the sensitivity may refer to a ratio between an input to a transducer element 206 and an output of the transducer element 206, a ratio between an output a transducer element 206 and an input of the transducer element 206, or the like. As a particular example, the sensitivity may refer to a relationship between an amplitude of a transmit signal that is transmitted to a transducer element 206 and an amplitude of an ultrasound signal that is generated by the transducer element 206 based on the transmit signal. A transducer element might have an expected sensitivity that the transducer element 206 is expected to exhibit. Also, the transducer element 206 might have an actual sensitivity that the transducer element 206 actually exhibits in real-time. The sensitivity of the transducer element 206 may be caused by the characteristics or performance of the transducer element 206. Additionally, the sensitivity of the transducer element 206 may be affected by the characteristics or performance of the lens 202, the acoustic matching layer 204, the acoustic dematching layer 208, the backing layer 210, or the like. Further, the sensitivity of the transducer element 206 may be affected by the characteristics or performance of electrical connections, connections between layers, or the like.

According to an embodiment, the processor 114 may determine a sensitivity of a transducer element 206 while the ultrasound probe 102 is in a calibration mode. In the calibration mode, the ultrasound probe 102 may be positioned in a particular location with respect to a housing of the ultrasound system 100. For example, the ultrasound probe 102 may be positioned in a probe holder of the ultrasound system 100. Alternatively, the ultrasound probe 102 may be positioned in a particular orientation, may be positioned in a particular arrangement, or the like, with respect to the ultrasound system 100. According to an embodiment, the ultrasound probe 102 may be positioned away from, or not in contact with, a subject to be imaged while the ultrasound probe 102 is in the calibration mode. For example, the ultrasound probe 102 may be positioned such that the lens 202 and/or a cap of the ultrasound probe 102 is not contacting any object and/or is not adjacent to any object. Alternatively, the ultrasound probe 102 may be positioned such that the lens 202 and/or a cap of the ultrasound probe 102 is contacting, or is adjacent to, a calibration object that produces echo signals that exhibit a known quality in response to ultrasound signals.

According to an embodiment, the processor 114 may determine a sensitivity of the transducer element 206 based on a calibration transmit signal and a calibration electrical signal corresponding to an echo signal generated based on the calibration transmit signal. For example, the processor 114 may control the arbitrary waveform transmitter 106 to generate a calibration transmit signal, and transmit the calibration transmit signal to a transducer element 206. The transducer element 206 may receive the calibration transmit signal from the arbitrary waveform transmitter 106, transform the calibration transmit signal to a calibration ultrasound signal, and transmit the calibration ultrasound signal towards the lens 202 of the ultrasound probe 102. The calibration ultrasound signal may be reflected by, or back-scattered from, an interface, and generate a calibration echo signal that may be reflected towards the transducer element 206. The transducer element 206 of the ultrasound probe 102 may receive the calibration echo signal, transform the calibration echo signal to a calibration electrical signal, and transmit the calibration electrical signal to the receiver 108. The interface may be an interface between the lens 202 of the ultrasound probe 102 and a cap of the ultrasound probe 102 or air, an interface between the transducer element 206 and the acoustic matching layer 204, an interface between various acoustic matching layers 204, an interface between the acoustic matching layer 204 and the lens 202, an interface between the lens 202 and air, an interface between the lens 202 and oil, an interface between oil and the cap, an interface between the cap and air, an interface between the cap and tissue, an interface between the cap and a phantom, an interface between the lens 202 and tissue, an interface between the lens 202 and the phantom, or the like.

According to an embodiment, the processor 114 may determine a sensitivity of the transducer element 206 based on a value of the calibration transmit signal and a value of the calibration electrical signal corresponding to the calibration echo signal generated based on the calibration transmit signal. For example, the value of the calibration transmit signal may be an amplitude value, a power value, an intensity value, a frequency value, a period value, a wavelength value, or the like. Additionally, the value of the calibration electrical signal may be an amplitude value, a power value, an intensity value, a frequency value, a period value, a wavelength value, or the like. According to an embodiment, the processor 114 may determine the sensitivity based on the values, based on a ratio between the values, or the like. In this way, the processor 114 may determine an actual sensitivity of the transducer element 206.

According to an embodiment, the processor 114 may determine a respective sensitivity of each of the transducer elements 206 of the ultrasound probe 102. For example, the processor 114 may perform the foregoing operations for each of the transducer elements 206, and determine a respective sensitivity of each of the transducer elements 206. Alternatively, the processor 114 may determine a respective sensitivity of a subset of the transducer elements 206. For example, the subset of the transducer elements 206 may be transducer elements 206 that are exhibiting anomalous behavior, that are prone to degradation, that are generating electrical signals that do not satisfy a threshold, that are selected by the user, or the like. The ultrasound probe 102 may include any number of transducer elements 206, and may include any configuration of transducer elements 206. For example, the ultrasound probe 102 may include a one-dimensional (1D) array of n transducer elements 206. Alternatively, the ultrasound probe 102 may include a two-dimensional (2D) grid of m×p transducer elements. Here, “n,” “m,” and “p” may be any number, and may be the same, or different, numbers as each other.

According to an embodiment, the processor 114 may determine a sensitivity of a transducer element 206 based on an input via the user input device 112. For example, a user may interact with the user input device 112 to cause the processor 114 to determine a sensitivity of a transducer element 206. Alternatively, the processor 114 may determine a sensitivity of a transducer element 206 based on a timeframe. For example, the processor 114 may determine a sensitivity of a transducer element 206 every hour, every week, every month, or the like. Alternatively, the processor 114 may determine a sensitivity of a transducer element 206 based on an event. For example, the processor 114 may determine a sensitivity of a transducer element 206 based on the ultrasound probe 102 being selected for usage, based on the ultrasound system 100 being powered on, based on the detection of a drop of the ultrasound probe 102, or the like.

As further shown in FIG. 3, the process 300 may include determining a correction factor for the transducer element based on the determined sensitivity (operation 320). The correction factor may refer to an amount by which a transmit signal for a transducer element 206 is adjusted to compensate for a determined sensitivity of the transducer element 206. For example, if the determined sensitivity of a transducer element 206 is substantially the same as an expected sensitivity of the transducer element 206, then the correction factor may be zero or relatively low. Alternatively, if the determined sensitivity of a transducer element 206 is substantially different than as compared to an expected sensitivity of the transducer element 206, then the correction factor may be non-zero and relatively greater.

According to an embodiment, the processor 114 may determine a correction factor, or a correction function, for a transducer element 206 based on the determined sensitivity of the transducer element 206 and an expected sensitivity of the transducer element 206. The memory 118 may store a data structure that includes expected sensitivities of the transducer elements 206. Additionally, or alternatively, the memory 118 may store a data structure that maps a correction factor, or a correction function, to a determined sensitivity. Additionally, or alternatively, the memory 118 may store a data structure that maps a correction factor, or a correction function, to a difference between a determined sensitivity and an expected sensitivity. Additionally, or alternatively, the memory 118 may store a data structure that maps a correction factor, or a correction function, to a range of sensitivities. The processor 114 may use any of the foregoing data structures to determine the correction factor or the correction function. Alternatively, the processor 114 may determine a specific correction factor, or a specific correction function, based on a specific determined sensitivity of the transducer element 206. The processor 114 may determine a respective correction factor, or correction function, for each of the transducer elements 206 of the ultrasound probe 102.

According to an embodiment, the processor 114 may determine a correction factor, or a correction function, for a transducer element 206 using an artificial intelligence (AI) model based on the determined sensitivity of the transducer element 206 and an expected sensitivity of the transducer element 206. The AI model may be a convolutional neural network (CNN) model, a residual neural network, a random forest model, a decision tree model, an artificial neural network (ANN), a Naïve Bayes model, a decision tree, a recurrent neural network (RNN), a logistic regression model, a support vector machine, or the like. The processor 114 may input the determined sensitivity of the transducer element 206 and the expected sensitivity of the transducer element 206 into the AI model, and determine the correction factor, or the correction function, for the transducer element 206 based on an output of the AI model.

According to an embodiment, the processor 114 may determine a correction factor, or a correction function, for a particular transmit setting of the ultrasound probe 102. For example, the processor 114 may determine a first correction factor, or a first correction function, for a first transmit setting, may determine a second correction factor, or a second correction function, for a second transmit setting, etc. According to an embodiment, the processor 114 may determine a correction function for a particular transmit setting with different frequency components. For example, the correction function may adjust the value of a transmit signal for a particular frequency component or a set of different frequency components. For instance, the processor 114 may determine a frequency response of the transducer element 206, and determine a correction function based on the frequency response of the transducer element 206.

As further shown in FIG. 3, the process 300 may include controlling an arbitrary waveform transmitter to generate an element specific transmit signal based on the correction factor for the transducer element (operation 330). The element specific transmit signal may refer to a transmit signal that is adjusted by the correction factor, and that is specific to a particular transducer element 206. In other words, the element specific transmit signal is influenced by, and accounts for, the determined sensitivity of a particular transducer element 206. For example, if the correction factor for a transducer element 206 is a first value, then the element specific transmit signal for the transducer element 206 may have a first characteristic. Further, if the correction factor for a transducer element 206 is a second value, then the element specific transmit signal for the transducer element 206 may have a second characteristic. The characteristic may be an amplitude value, a power value, an intensity value, a frequency value, a period value, a wavelength value, or the like. Additionally, the value of the calibration electrical signal may be an amplitude value, a power value, an intensity value, a frequency value, a period value, a wavelength value, or the like.

According to an embodiment, the processor 114 may control the arbitrary waveform transmitter 106 to generate the element specific transmit signal based on the correction factor. The arbitrary waveform transmitter 106 may generate the element specific transmit signal to have a particular value (e.g., a particular amplitude value) based on the correction factor and a predetermined value (e.g., a predetermined amplitude value).

As further shown in FIG. 3, the process 300 may include controlling the arbitrary waveform transmitter to transmit the element specific transmit signal to the transducer element to cause the transducer element to generate an ultrasound signal (operation 340). The processor 114 may control the arbitrary waveform transmitter 106 to transmit the element specific transmit signal to the transducer element 206. In this way, the transducer element 206 may receive the element specific transmit signal, and transform the element specific transmit signal to an ultrasound signal. The ultrasound signal may have a value that more closely aligns with an expected value because the element specific transmit signal was generated using the correction factor that accounts for the determined sensitivity of the transducer element 206.

Although FIG. 3 depicts particular operations and a particular sequence of operations, it should be understood that other embodiments may include different operations and/or a different sequence of operations than as shown in FIG. 3.

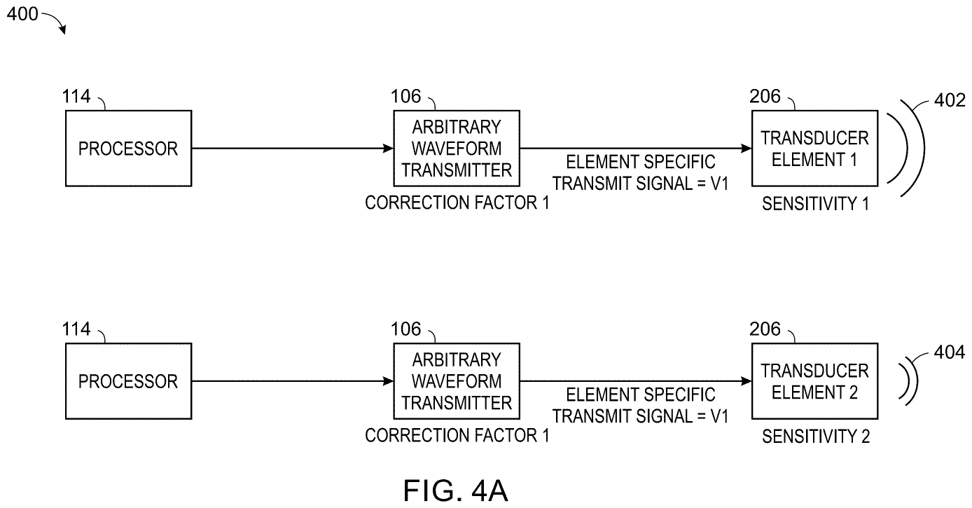

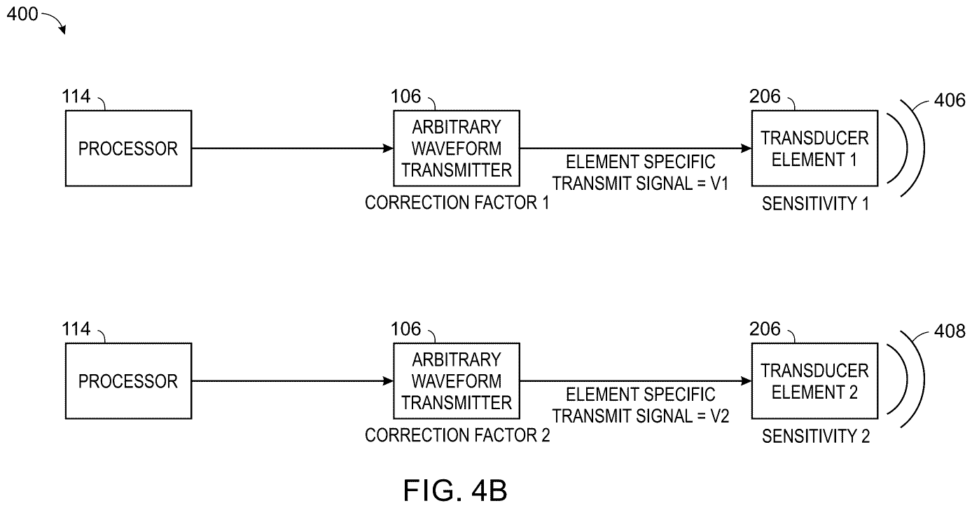

FIGS. 4A and 4B are diagrams of an example process 400 for controlling an arbitrary waveform transmitter to transmit an element specific transmit signal to a transducer element. As shown in FIG. 4A, the processor 114 may control the arbitrary waveform transmitter 106 to generate and transmit an element specific transmit signal having a first voltage (V1) determined based on a first correction factor (correction factor 1) to a first transducer element 206 (transducer element 1) that has a first sensitivity (sensitivity 1) to cause the first transducer element 206 (transducer element 1) to generate an ultrasound signal 402 having a particular amplitude. Further, as shown in FIG. 4A, the processor 114 may control the arbitrary waveform transmitter 106 to generate and transmit an element specific transmit signal having a first voltage (V1) determined based on a first correction factor (correction factor 1) to a second transducer element 206 (transducer element 2) that has a second sensitivity (sensitivity 2) to cause the second transducer element 206 (transducer element 2) to generate an ultrasound signal 404 having a particular amplitude. As shown, the amplitude of the ultrasound signal 404 is less than the amplitude of the ultrasound signal 402 because the sensitivity of the second transducer element 206 is different than the sensitivity of the first transducer element 206.

As shown in FIG. 4B, the processor 114 may control the arbitrary waveform transmitter 106 to generate and transmit an element specific transmit signal having a first voltage (V1) and/or first frequency components determined based on a first correction factor (correction factor 1) or a first correction function to a first transducer element 206 (transducer element 1) that has a first sensitivity (sensitivity 1) to cause the first transducer element 206 (transducer element 1) to generate an ultrasound signal 406 having a particular amplitude. Further, as shown in FIG. 4B, the processor 114 may control the arbitrary waveform transmitter 106 to generate and transmit an element specific transmit signal having a second voltage (V2) and/or second frequency components determined based on a second correction factor (correction factor 2) or a second correction function to a second transducer element 206 (transducer element 2) that has a second sensitivity (sensitivity 2) to cause the second transducer element 206 (transducer element 2) to generate an ultrasound signal 408 having a particular amplitude. As shown, the amplitude of the ultrasound signal 406 is substantially the same as the amplitude of the ultrasound signal 408 despite the sensitivity of the second transducer element 206 being different than the sensitivity of the first transducer element 206. In this way, the second correction factor results in the generation of an element specific transmit signal for the second transducer element 206 having an increased voltage (V2) as compared to the voltage (V1) of the element specific transmit signal for the first transducer element 206. Further, in this way, the increased voltage (V2) of the element specific transmit signal for the second transducer element 206 causes the generation of the ultrasound signal 408 that has a similar amplitude as compared to the ultrasound signal 406.

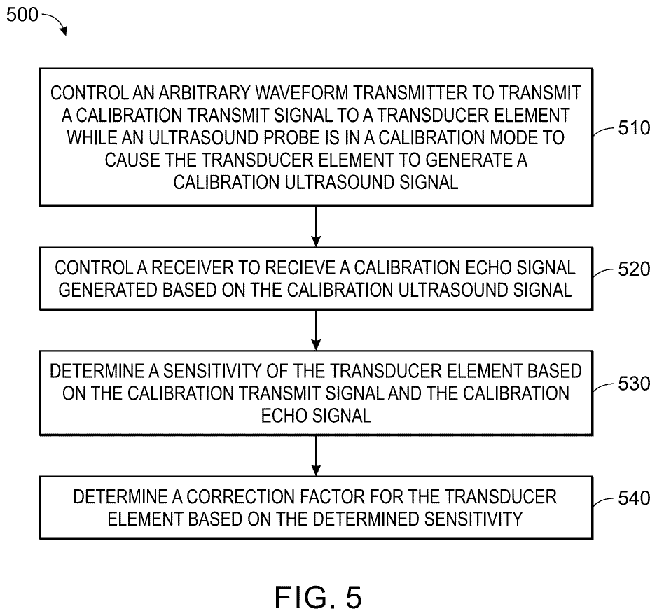

FIG. 5 is a flowchart of an example process 500 for determining a correction factor for a transducer element while an ultrasound probe is in a calibration mode. According to an embodiment, the process 500 may be performed by the processor 114. Additionally, or alternatively, one or more operations of the process 500 may be performed by another component of the ultrasound system 100, such as the ultrasound probe 102, the transmit beamformer 104, the arbitrary waveform transmitter 106, the receiver 108, the receive beamformer 110, the user input device 112, the display 116, the memory 118, and/or the communication interface 120.

As shown in FIG. 5, the process 500 may include controlling an arbitrary waveform transmitter to transmit a calibration transmit signal to a transducer element while an ultrasound probe is in a calibration mode to cause the transducer element to generate a calibration ultrasound signal (operation 510). For example, the processor 114 may control the arbitrary waveform transmitter 106 to generate a calibration transmit signal, and transmit the calibration transmit signal to a transducer element 206. In the calibration mode, the ultrasound probe 102 may be positioned in a particular location with respect to a housing of the ultrasound system 100. For example, the ultrasound probe 102 may be positioned in a probe holder of the ultrasound system 100. Alternatively, the ultrasound probe 102 may be positioned in a particular orientation, may be positioned in a particular arrangement, or the like, with respect to the ultrasound system 100. According to an embodiment, the ultrasound probe 102 may be positioned away from, or not in contact with, a subject to be imaged while the ultrasound probe 102 is in the calibration mode. For example, the ultrasound probe 102 may be positioned such that the lens 202 and/or a cap of the ultrasound probe 102 is not contacting any object and/or is not adjacent to any object. Alternatively, the ultrasound probe 102 may be positioned such that the lens 202 and/or a cap of the ultrasound probe 102 is contacting, or is adjacent to, a calibration object that produces echo signals that exhibit a known quality in response to ultrasound signals.

The transducer element 206 may receive the calibration transmit signal from the arbitrary waveform transmitter 106, transform the calibration transmit signal to a calibration ultrasound signal, and transmit the calibration ultrasound signal towards the lens 202 of the ultrasound probe 102. The calibration ultrasound signal may be reflected by, or back-scattered from, an interface, and generate a calibration echo signal that may be reflected towards the transducer element 206. The transducer element 206 of the ultrasound probe 102 may receive the calibration echo signal, transform the calibration echo signal to a calibration electrical signal, and transmit the calibration electrical signal to the receiver 108. The interface may be an interface between the lens 202 of the ultrasound probe 102 and a cap of the ultrasound probe 102 or air, an interface between the transducer element 206 and the acoustic matching layer 204, an interface between various acoustic matching layers 204, an interface between the acoustic matching layer 204 and the lens 202, an interface between the lens 202 and air, an interface between the lens 202 and oil, an interface between oil and the cap, an interface between the cap and air, an interface between the cap and tissue, an interface between the cap and a phantom, an interface between the lens 202 and tissue, an interface between the lens 202 and the phantom, or the like.

As further shown in FIG. 5, the process 500 may include controlling a receiver to receive a calibration echo signal generated based on the calibration ultrasound signal (operation 520). For example, the processor 114 may control the receiver 108 to receive the calibration echo signal generated based on the calibration ultrasound signal.

As further shown in FIG. 5, the process 500 may include determining a sensitivity of the transducer element based on the calibration transmit signal and the calibration echo signal (operation 530). For example, the processor 114 may determine a sensitivity of the transducer element 206 based on a value of the calibration transmit signal and a value of the calibration electrical signal corresponding to the calibration echo signal generated based on the calibration transmit signal, as described in a similar manner in connection with operation 310 of FIG. 3.

As further shown in FIG. 5, the process 500 may include determining a correction factor for the transducer element based on the determined sensitivity (operation 540). For example, the processor 114 may determine a correction factor for the transducer element 206 in a similar manner as described above in connection with operation 320 of FIG. 3.

Although FIG. 5 depicts particular operations and a particular sequence of operations, it should be understood that other embodiments may include different operations and/or a different sequence of operations than as shown in FIG. 5.

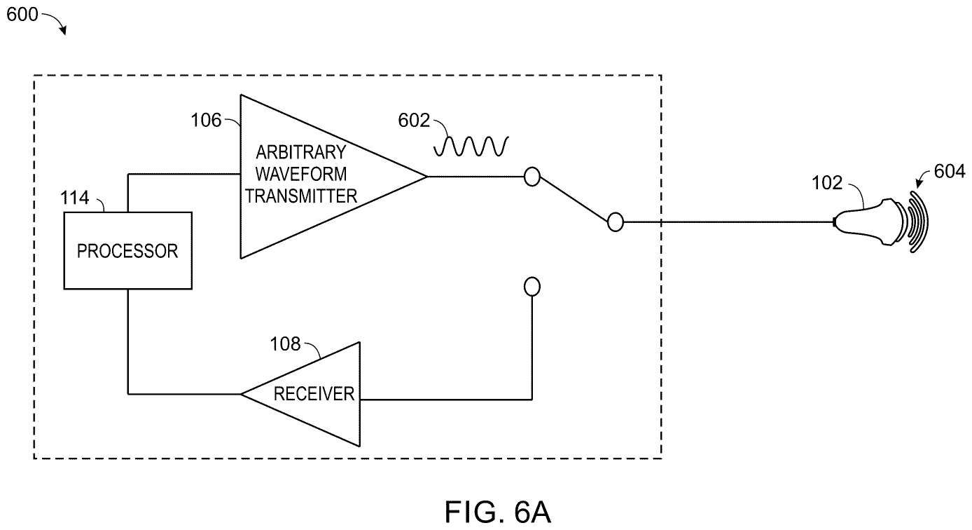

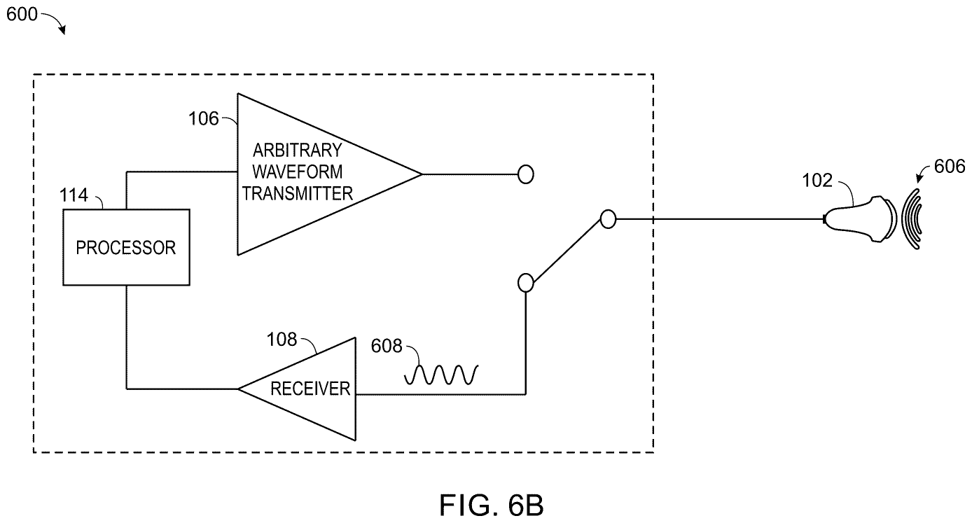

FIGS. 6A and 6B are diagrams of an example process 600 for determining a correction factor for a transducer element 206 while an ultrasound probe 102 is in a calibration mode. As shown in FIG. 6A, the processor 114 may control the arbitrary waveform transmitter 106 to generate a calibration transmit signal 602, and transmit the calibration transmit signal 602 to a transducer element 206 of the ultrasound probe 102. The transducer element 206 may receive the calibration transmit signal 602 from the arbitrary waveform transmitter 106, transform the calibration transmit signal 602 to a calibration ultrasound signal 604, and transmit the calibration ultrasound signal 604 towards the lens 202 of the ultrasound probe 102. As shown in FIG. 6B, the calibration ultrasound signal 604 may be reflected by, or back-scattered from, an interface, and generate a calibration echo signal 606 that may be reflected towards the transducer element 206. The transducer element 206 of the ultrasound probe 102 may receive the calibration echo signal 606, transform the calibration echo signal 606 to a calibration electrical signal 608, and transmit the calibration electrical signal 608 to the receiver 108. The processor 114 may determine a sensitivity of the transducer element 206 based on a value of the calibration transmit signal 602 and a value of the calibration electrical signal 608 corresponding to the calibration echo signal 606 generated based on the calibration transmit signal 602. The interface may be an interface between the lens 202 of the ultrasound probe 102 and a cap of the ultrasound probe 102 or air, an interface between the transducer element 206 and the acoustic matching layer 204, an interface between various acoustic matching layers 204, an interface between the acoustic matching layer 204 and the lens 202, an interface between the lens 202 and air, an interface between the lens 202 and oil, an interface between oil and the cap, an interface between the cap and air, an interface between the cap and tissue, an interface between the cap and a phantom, an interface between the lens 202 and tissue, an interface between the lens 202 and the phantom, or the like.

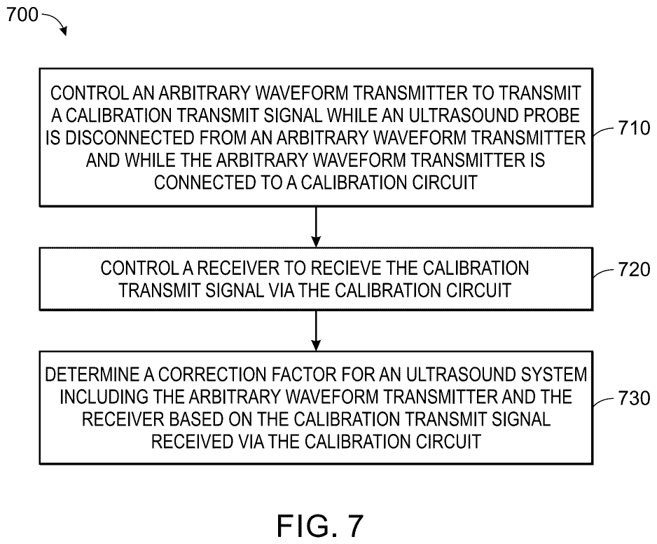

FIG. 7 is a flowchart of an example process 700 for determining a correction factor for an ultrasound system using a calibration circuit. According to an embodiment, the process 700 may be performed by the processor 114. Additionally, or alternatively, one or more operations of the process 700 may be performed by another component of the ultrasound system 100, such as the ultrasound probe 102, the transmit beamformer 104, the arbitrary waveform transmitter 106, the receiver 108, the receive beamformer 110, the user input device 112, the display 116, the memory 118, and/or the communication interface 120.

As shown in FIG. 7, the process 700 may include controlling an arbitrary waveform transmitter to transmit a calibration transmit signal while an ultrasound probe is disconnected from an arbitrary waveform transmitter and while the arbitrary waveform transmitter is connected to a calibration circuit (operation 710). The calibration circuit may be a circuit that is configured to permit the determination of a correction factor for the ultrasound system 100. For example, the calibration circuit may be a circuit that connects the arbitrary waveform transmitter 106 and the receiver 108. The correction factor for the ultrasound system 100 may be separate from a correction factor for a transducer element 206 of the ultrasound probe 102, and may be determined when the ultrasound probe 102 is disconnected from the arbitrary waveform transmitter 106. In other words, the correction factor might account for anomalous behavior of the ultrasound system 100 that is not related to the ultrasound probe 102. The processor 114 may control the arbitrary waveform transmitter 106 to generate and transmit the calibration transmit signal while the arbitrary waveform transmitter 106 is connected to the calibration circuit. In this case, the calibration transmit signal may pass through the calibration circuit, and be received by the receiver 108.

As further shown in FIG. 7, the process 700 may include controlling a receiver to receive the calibration transmit signal via the calibration circuit (operation 720). For example, the processor 114 may control the receiver 108 to receive the calibration transmit signal that passed through the calibration circuit.

As further shown in FIG. 7, the process 700 may include determining a correction factor for an ultrasound system including the arbitrary waveform transmitter and the receiver based on the calibration transmit signal received via the calibration circuit (operation 730). For example, the processor 114 may determine a correction factor for the ultrasound system 100 including the arbitrary waveform transmitter 106 and the receiver 108 based on the calibration transmit signal received via the calibration circuit.

According to an embodiment, the processor 114 may determine the correction factor for the ultrasound system 100 based on a characteristic of the calibration transmit signal transmitted by the arbitrary waveform transmitter 106 and based on a characteristic of the calibration transmit signal received by the receiver 108 via the calibration circuit. For example, the processor 114 may compare a characteristic of the calibration transmit signal transmitted by the arbitrary waveform transmitter 106 and a characteristic of the calibration transmit signal received by the receiver 108 via the calibration circuit, and determine the correction factor based on the comparison.

According to an embodiment, the memory 118 may store a data structure that maps a correction factor to a characteristic of a calibration transmit signal received by the receiver 108 via the calibration circuit. Additionally, or alternatively, the memory 118 may store a data structure that maps a correction factor to a difference between a determined characteristic of a calibration transmit signal received by the receiver 108 via the calibration circuit an expected characteristic of a calibration transmit signal received by the receiver 108 via the calibration circuit. Additionally, or alternatively, the memory 118 may store a data structure that maps a correction factor to a difference between a characteristic of a calibration transmit signal transmitted by the arbitrary waveform transmitter 106 and a determined characteristic of a calibration transmit signal received by the receiver 108 via the calibration circuit. The processor 114 may use any of the foregoing data structures to determine the correction factor. Additionally, or alternatively, the processor 114 may determine the correction factor using an AI model. For example, the processor 114 may input the determined characteristic of the calibration transmit signal received by the receiver 108 via the calibration circuit into the AI model, and determine the correction factor based on an output of the AI model. Alternatively, the processor 114 may input the determined characteristic of the calibration transmit signal received by the receiver 108 via the calibration circuit and a characteristic of the calibration transmit signal transmitted by the arbitrary waveform transmitter 106 into the AI model, and determine the correction factor based on an output of the AI model.

The processor 114 may apply the correction factor for the ultrasound system 100 to one or more element specific transmit signals transmitted to respective transducer elements 206 of the ultrasound probe 102 in addition to respective correction factors for the transducer elements 206 of the ultrasound probe 102. In other words, the correction factor for the ultrasound system 100 may apply to all transducer elements 206 and may account for system performance of the entire ultrasound system 100, whereas a particular correction factor for a particular transducer element 206 may correspond to only the particular transducer element 206 and may account for only performance of the particular transducer element 206.

Although FIG. 7 depicts particular operations and a particular sequence of operations, it should be understood that other embodiments may include different operations and/or a different sequence of operations than as shown in FIG. 7.

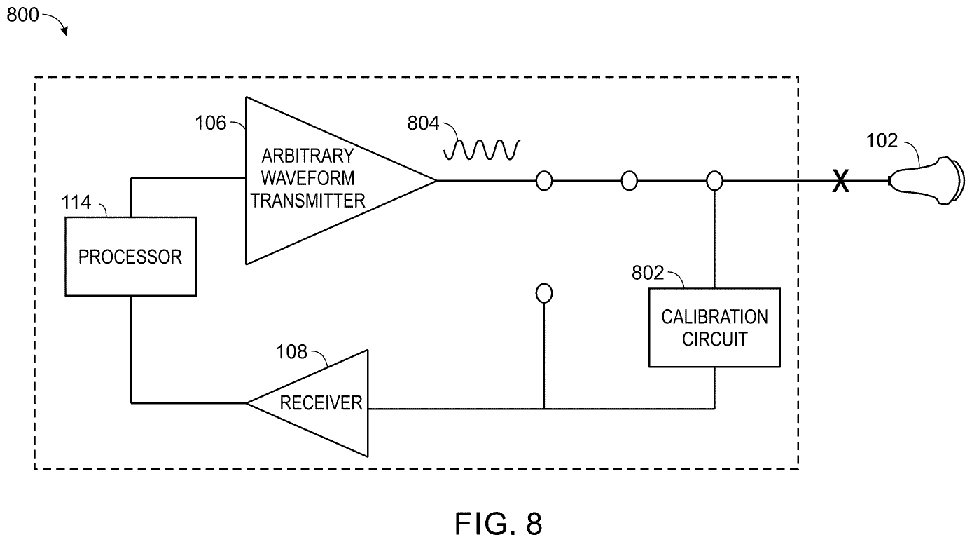

FIG. 8 is a diagram 800 of an example process for determining a correction factor for an ultrasound system using a calibration circuit. As shown in FIG. 8, the arbitrary waveform transmitter 106 or any other signal generating circuit (e.g., a dedicated signal generator) may be connected to the receiver 108 via a calibration circuit 802. Further, as shown in FIG. 8, the ultrasound probe 102 might not be connected to the arbitrary waveform transmitter 106. In this case, the processor 114 may control the arbitrary waveform transmitter 106 to generate and transmit a calibration transmit signal 804. The arbitrary waveform transmitter 106 may generate and transmit the calibration transmit signal 804 to the calibration circuit 802, which passes the calibration transmit signal 804 to the receiver 108. The receiver 108 may receive the calibration transmit signal 804, and transmit the calibration transmit signal 804 to the processor 114. The processor 114 may determine a correction factor for the ultrasound system 100 based on the calibration transmit signal 804 received by the receiver 108 via the calibration circuit 802.

According to an embodiment, the ultrasound system 100 may use an AI model. The one or more AI models may be associated with a training phase, a deployment phase, and a monitoring phase. In the training phase, the ultrasound system 100 may receive and process training data to generate a trained model. The training data may be generated, received, or otherwise obtained from internal and/or external resources.

Generally, the trained model may include a set of variables (e.g., nodes, neurons, filters, or the like) that are tuned (e.g., weighted, biased, or the like) to different values via the application of the training data. According to an embodiment, the training process may employ supervised, unsupervised, semi-supervised, and/or reinforcement learning processes to train the model. According to an embodiment, a portion of the training data may be withheld during training and/or used to validate the trained model.

For supervised learning processes, the training data may include labels or scores that may facilitate the training process by providing a ground truth. For example, the labels or scores may indicate an output of the model. Training may proceed by feeding a training dataset including the training data into the model. The model may have variables set at initialized values (e.g., at random, based on Gaussian noise, based on pre-trained values, or the like). The model may generate an output based on the training dataset being input to the model. The output may be compared with the corresponding label or score (e.g., the ground truth) indicating the known output, which may then be back-propagated through the model to adjust the values of the variables. This process may be repeated for a plurality of samples at least until a determined loss or error is below a predefined threshold. According to an embodiment, some of the training data may be withheld and used to further validate or test the trained model.

For unsupervised learning processes, the training data may not include pre-assigned labels or scores to aid the learning process. Instead, unsupervised learning processes may include clustering, classification, or the like, to identify naturally occurring patterns in the training data. As an example, the training data may be clustered into groups based on identified similarities and/or patterns. K-means clustering or K-Nearest Neighbors may also be used, which may be supervised or unsupervised. Combinations of K-Nearest Neighbors and an unsupervised cluster technique may also be used. For semi-supervised learning, a combination of training data with pre-assigned labels or scores and training data without pre-assigned labels or scores may be used to train the model.

When reinforcement learning is employed, an agent (e.g., an algorithm) may be trained to make a decision from the training data through trial and error. For example, based on making a decision, the agent may then receive feedback (e.g., a positive reward if the prediction was above a predetermined threshold), adjust its next decision to maximize the reward, and repeat until a loss function is optimized.

After being trained, the trained model may be stored and subsequently applied by the ultrasound system 100 during the deployment phase. For example, during the deployment phase, the trained model executed by the ultrasound system 100 may receive input data. During the deployment phase, the trained model may perform one or more operations as described in connection with FIG. 3.

After being deployed, the trained model may be monitored during the monitoring phase. For example, during the monitoring phase, the model may generate monitoring data that is used to monitor the trained model. The monitoring data may include data that identifies an output as determined by an operator. During the monitoring phase, monitoring data may be analyzed along with the predicted output data and input data to determine an accuracy of the trained model. According to an embodiment, based on the analysis, the process may return to the training phase, where values of one or more variables of the model may be adjusted to improve the accuracy of the model.

Embodiments of the present disclosure shown in the drawings and described above are example embodiments only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present invention. That is, features of the described embodiments can be combined with any appropriate aspect described above and optional features of any one aspect can be combined with any other appropriate aspect. Similarly, features set forth in dependent claims can be combined with non-mutually exclusive features of other dependent claims, particularly where the dependent claims depend on the same independent claim. Single claim dependencies may have been used as practice in some jurisdictions require them, but this should not be taken to mean that the features in the dependent claims are mutually exclusive.

What is claimed is:

1. An ultrasound system comprising:
a lens, an acoustic matching layer, an acoustic dematching layer, and a plurality of transducer elements;
a memory configured to store instructions; and
one or more processors configured to execute the instructions to:
determine a sensitivity of a transducer element of the plurality of transducer elements;
determine a correction factor for the transducer element based on the determined sensitivity;
control an arbitrary waveform transmitter to generate an element specific transmit signal based on the correction factor for the transducer element; and
control the arbitrary waveform transmitter to transmit the element specific transmit signal to the transducer element to cause the transducer element to generate an ultrasound signal.

2. The ultrasound system of claim 1, wherein the one or more processors are configured to control the arbitrary waveform transmitter to generate the element specific transmit signal having a voltage that is determined by the correction factor.

3. The ultrasound system of claim 1, wherein the one or more processors are configured to control the arbitrary waveform transmitter to generate the element specific transmit signal having a voltage for a particular transmit setting with different frequency components that is determined by the correction factor.

4. The ultrasound system of claim 1, wherein the sensitivity is a ratio of an output of the transducer element to an input of the transducer element.

5. The ultrasound system of claim 1, wherein the one or more processors are further configured to:
control the arbitrary waveform transmitter to transmit a calibration transmit signal to the transducer element while the ultrasound probe is in a calibration mode to cause the transducer element to generate a calibration ultrasound signal; and
control a receiver to receive a calibration echo signal generated based on the calibration ultrasound signal,
wherein the one or more processors, when determining the correction factor, are configured to determine the correction factor based on the calibration transmit signal and the calibration echo signal.

6. The ultrasound system of claim 1, wherein the one or more processors are further configured to:
control the arbitrary waveform transmitter to transmit a calibration transmit signal while the ultrasound probe is disconnected from the arbitrary waveform transmitter and while the arbitrary waveform transmitter is connected to a calibration circuit;
control a receiver to receive the calibration transmit signal via the calibration circuit; and
determine another correction factor for the ultrasound system including the arbitrary waveform transmitter and the receiver based on the calibration transmit signal received via the calibration circuit.

7. The ultrasound system of claim 1, wherein the one or more processors are further configured to:
determine a respective correction factor for each of the transducer elements of the plurality of transducer elements.

8. A method comprising:
determining a sensitivity of a transducer element of a plurality of transducer elements of an ultrasound probe comprising a lens, an acoustic matching layer, an acoustic dematching layer, and the plurality of transducer elements;
determining a correction factor for the transducer element based on the determined sensitivity;
controlling an arbitrary waveform transmitter to generate an element specific transmit signal based on the correction factor for the transducer element; and
controlling the arbitrary waveform transmitter to transmit the element specific transmit signal to the transducer element to cause the transducer element to generate an ultrasound signal.

9. The method of claim 8, wherein the controlling the arbitrary waveform transmitter to generate the element specific transmit signal comprises:
controlling the arbitrary waveform transmitter to generate the element specific transmit signal having a voltage that is determined by the correction factor.

10. The method of claim 8, wherein the controlling the arbitrary waveform transmitter to generate the element specific transmit signal comprises:
controlling the arbitrary waveform transmitter to generate the element specific transmit signal having a voltage for a particular transmit setting with different frequency components that is determined by the correction factor.

11. The method of claim 8, wherein the sensitivity is a ratio of an output of the transducer element to an input of the transducer element.

12. The method of claim 8, further comprising:
controlling the arbitrary waveform transmitter to transmit a calibration transmit signal to the transducer element while the ultrasound probe is in a calibration mode to cause the transducer element to generate a calibration ultrasound signal; and
controlling a receiver to receive a calibration echo signal generated based on the calibration ultrasound signal,
wherein the determining the correction factor comprises determining the correction factor based on the calibration transmit signal and the calibration echo signal.

13. The method of claim 8, further comprising:
controlling the arbitrary waveform transmitter to transmit a calibration transmit signal while the ultrasound probe is disconnected from the arbitrary waveform transmitter and while the arbitrary waveform transmitter is connected to a calibration circuit;
controlling a receiver to receive the calibration transmit signal via the calibration circuit; and
determining another correction factor for an ultrasound system including the arbitrary waveform transmitter and the receiver based on the calibration transmit signal received via the calibration circuit.

14. The method of claim 8, further comprising:
determining a respective correction factor for each of the transducer elements of the plurality of transducer elements.

15. A non-transitory computer-readable medium storing instructions that, when executed by one or more processors of an ultrasound system, cause the one or more processors to:
determine a sensitivity of a transducer element of a plurality of transducer elements of an ultrasound probe comprising a lens, an acoustic matching layer, an acoustic dematching layer, and the plurality of transducer elements;
determine a correction factor for the transducer element based on the determined sensitivity;
control an arbitrary waveform transmitter to generate an element specific transmit signal based on the correction factor for the transducer element; and
control the arbitrary waveform transmitter to transmit the element specific transmit signal to the transducer element to cause the transducer element to generate an ultrasound signal.

16. The non-transitory computer-readable medium of claim 15, wherein the instructions, that cause the one or more processors to control the arbitrary waveform transmitter to generate the element specific transmit signal, cause the one or more processors to:
control the arbitrary waveform transmitter to generate the element specific transmit signal having a voltage that is determined by the correction factor.

17. The non-transitory computer-readable medium of claim 15, wherein the instructions, that cause the one or more processors to control the arbitrary waveform transmitter to generate the element specific transmit signal, cause the one or more processors to:
control the arbitrary waveform transmitter to generate the element specific transmit signal having a voltage for a particular transmit setting with different frequency components that is determined by the correction factor.

18. The non-transitory computer-readable medium of claim 15, wherein the sensitivity is a ratio of an output of the transducer element to an input of the transducer element.

19. The non-transitory computer-readable medium of claim 15, wherein the instructions further cause the one or more processors to:
control the arbitrary waveform transmitter to transmit a calibration transmit signal to the transducer element while the ultrasound probe is in a calibration mode to cause the transducer element to generate a calibration ultrasound signal; and
control a receiver to receive a calibration echo signal generated based on the calibration ultrasound signal,
wherein the instructions, that cause the one or more processors to determine the correction factor, further cause the one or more processors to determine the correction factor based on the calibration transmit signal and the calibration echo signal.

20. The non-transitory computer-readable medium of claim 15, wherein the instructions further cause the one or more processors to:
determine a respective correction factor for a plurality of frequencies.
